(19) United States
(12) Patent Application Publication
(10) Pub. No.: US 2011/0292674 A1
(43) Pub. Date: Dec. 1, 2011

(54) OPTICAL FIBER TEETH ILLUMINATION APPARATUS

(76) Inventor: Yan-Zhang LIN, Nantou County (TW)

(21) Appl. No.: 12/791,321

(22) Filed: Jun. 1, 2010

(51) Int. Cl. G02B 6/04

(52) U.S. Cl. 362/554; 362/573

(57) ABSTRACT

An optical fiber teeth illumination apparatus comprises a handle and a treatment device. The handle has a hollow lighting section at a front end to hold a lighting element and at least one optical fiber. The lighting element is connected to a power source. The lighting section has at least one aperture. The lighting element and the optical fiber are interposed by a condensing light element which focuses light generated by the lighting element on an input end of the optical fiber. The optical fiber has at least one output end facing the aperture to project the light outside. The treatment device is fastened to the front side of the lighting section. Thus dentists can correctly inspect ailing portion and perform treatment without holding a lighting device, and overcome the problem of holding multiple tools such as an oral mirror, lighting device and treatment apparatus at the same time.

### FIELD OF THE INVENTION

The present invention relates to an oral mirror used by dentists and particularly to an apparatus capable of emitting light through a handle to illuminate a patient's oral cavity to facilitate inspection or treatment for patient's teeth by the dentists.

### BACKGROUND OF THE INVENTION

In dental clinic, when a dentist wants to inspect or treat for patient's teeth, the dentist has to rely on an oral mirror as shown in FIG. 1 to push a patient's tongue or cheek aside to expose an entire individual tooth to make correct examination of the ailing portion. As external light usually is not sufficient to illuminate the interior of the patient's oral cavity as desired, the dentist commonly has to hold a flashlight with one hand and grasp the oral mirror with another hand to observe the ailing portion to do treatment. While grasping the oral mirror with one hand to push the patient's tongue or cheek aside to avert interference of the tooth, and the dentist also has to hold a treatment apparatus with another hand, then holding the flashlight becomes impossible. Thus the dentist usually has to wear a head lamp and bend the body to project the head lamp to the interior of the patient's oral cavity. Such a practice is tiresome and heavily taxes the dentist's physical strength during a prolonged period of inspection or treatment for the patient's teeth.

### SUMMARY OF THE INVENTION

The primary object of the present invention is to provide an optical fiber teeth illumination apparatus that can emit light to provide illumination to help a dentist to inspect or treat for patient's teeth and overcome the difficulty of holding multiple tools such as an oral mirror, lighting device and treatment apparatus at the same time.

To achieve the foregoing object, the invention provides an optical fiber teeth illumination apparatus which includes a handle and a treatment device. The handle has a hollow lighting section at a front end to hold a lighting element and at least one optical fiber. The lighting element is connected to a power source. The lighting section has at least one aperture. The lighting element and the optical fiber are interposed by a condensing light element. Through the condensing light element, the light generated by the lighting element is focused on an input end of the optical fiber. The optical fiber has at least one output end facing the aperture to project the light outside. The treatment device is fastened to the front side of the lighting section, thus is lit by the light from the lighting section.

By means of the construction set forth above, when the dentist inspects or treats for the patient's teeth, the lighting section emits the light to illuminate the treatment device, and the treatment device disposed into the patient's oral cavity also provides illumination. Hence the dentist does not have to wear a head lamp during inspection and treatment, and is free from the trouble of holding a lighting device such as a flashlight, therefore can overcome the problem of holding multiple tools such as the oral mirror, lighting device and treatment apparatus at the same time.

The foregoing, as well as additional objects, features and advantages of the invention will be more readily apparent from the following detailed description, which proceeds with reference to the accompanying embodiments and drawings. The embodiments serve merely for illustrative purpose and are not the limitations of the invention.

### BRIEF DESCRIPTION OF THE DRAWINGS

FIG. 1 is a perspective view of a conventional oral mirror used by dentists.

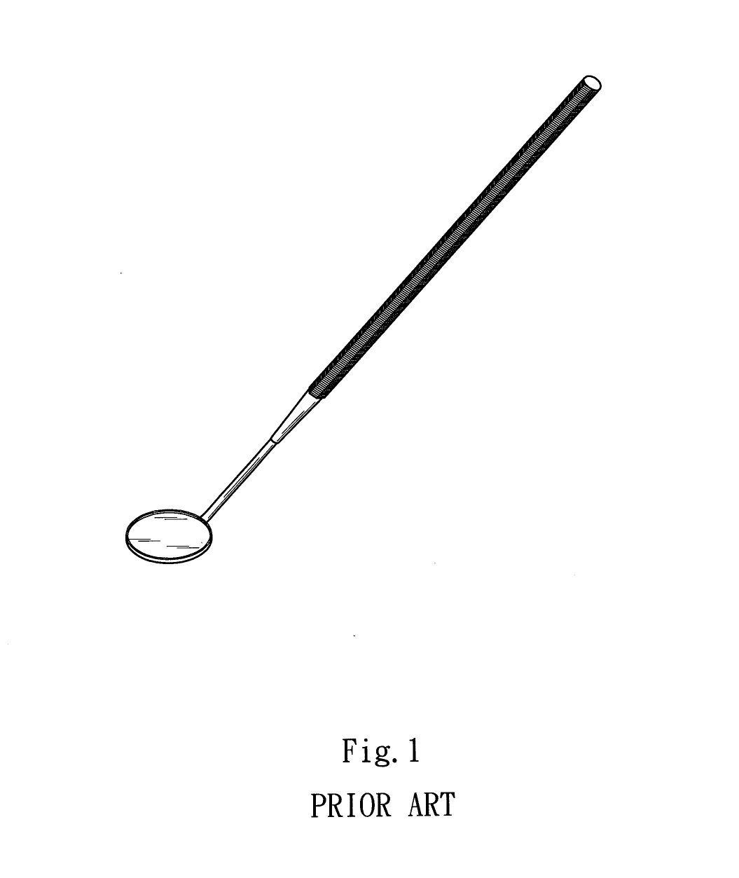

FIG. 2 is a sectional view of a first embodiment of the invention.

FIG. 3 is a sectional view of a second embodiment of the invention.

FIG. 4 is a perspective view of a third embodiment of the invention.

### DETAILED DESCRIPTION OF THE PREFERRED EMBODIMENTS

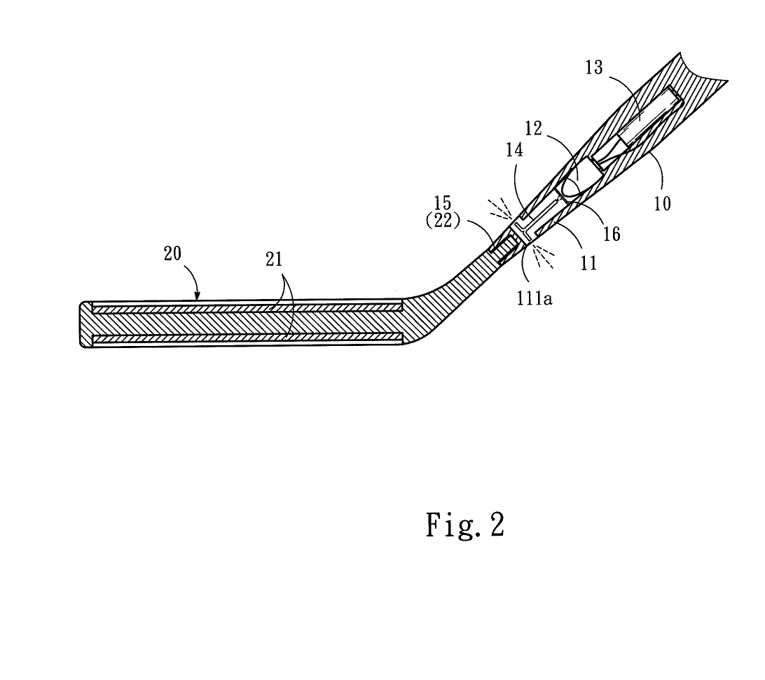

Please refer to FIG. 2 for a first embodiment of the optical fiber teeth illumination apparatus of the invention. It includes a handle 10 and a treatment device 20. The handle 10 has a bar-shaped hollow lighting section 11 at a front end that has at least one radial aperture 111a (two apertures 111a are formed in this embodiment) close to the treatment device 20, and a screw hole 15 at the front side fastenable with a fastening portion 22 formed at a rear side of the treatment device 20. The treatment device 20 can be a round oral mirror to push a patient's tongue or cheek aside, and has two mirror surfaces 21 on the upper and lower sides.

The lighting section 11 holds a lighting element (such as an LED) 12 and at least one optical fiber 14. The lighting element 12 is connected to a power source 13 such as a battery to emit light. The lighting element 12 and the optical fiber 14 are interposed by a condensing light element 16. Through the condensing light element 16, light generated by the lighting element 12 is focused on an input end of the optical fiber 14. The optical fiber 14 has at least one output end facing the aperture 111a to project the light outside.

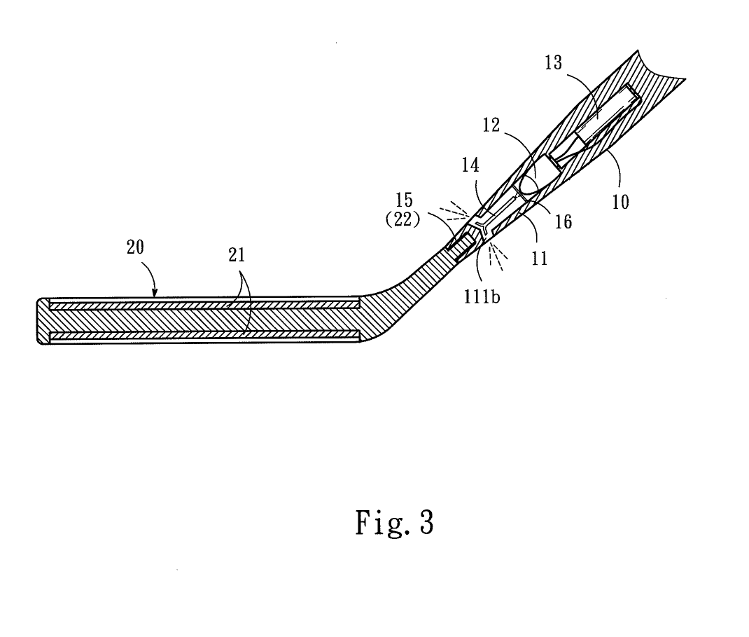

Refer to FIG. 3 for a second embodiment of the optical fiber teeth illumination apparatus of the invention. It is substantially constructed the same as the first embodiment previously discussed. It differs from having the aperture 111b formed in an inclined manner towards the treatment device 20. The output end of the optical fiber 14 is formed in the same direction as the inclined aperture 111b to project the light towards the treatment device 20.

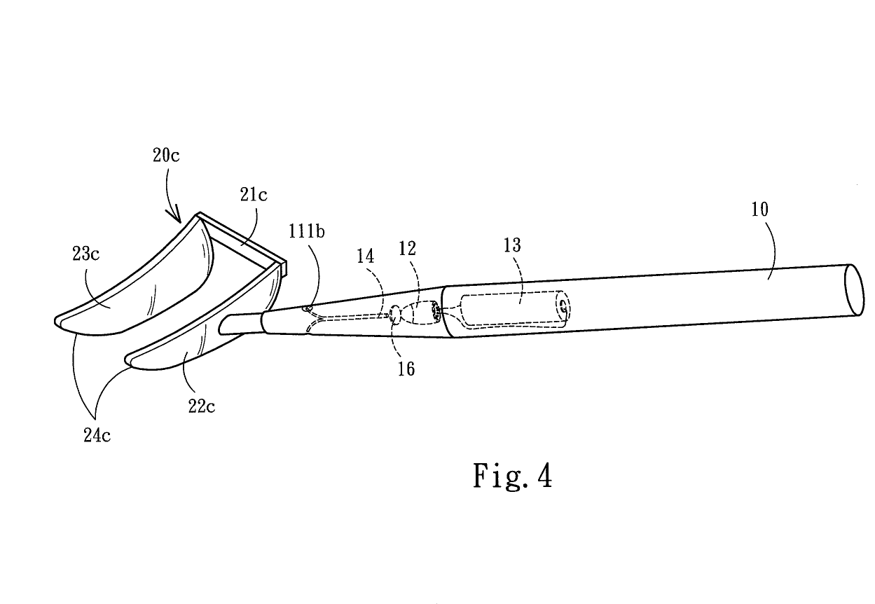

Refer to FIG. 4 for a third embodiment of the optical fiber teeth illumination apparatus of the invention. It shows that a treatment device 20c is an oral mirror formed in another shape which includes a connecting member 21c and a first extending wall 22c and a second extending wall 23c bridged by the connecting member 21c on the left side and right side in an U-shaped manner with an opening directing forwards. The connecting member 21c is spaced from the first and second extending walls 22c and 23c with a gap at the bottoms thereof. The front end of the handle 10 is connected to an outer side of the first extending wall 22c and inclined upwards. The first and second extending walls 22c and 23c are formed in an arched shape mating human's teeth gums. Moreover, the first and second extending walls 22c and 23c have upper sides spaced from each other at a distance greater than that of lower sides. The first and second extending walls 22c and 23c also have respectively a front end formed in an arched end 24c tilted upwards from a lower side to an upper side.

When the dentist inspects or treats for the patient's teeth, the lighting element 12 projects the light to the condensing light element 16, and the optical fiber 14 transmits the light to the apertures 111a or 111b to emit outside so that the mirror surfaces 21 can reflect the light to illuminate the patient's oral cavity. Thereby the dentist can inspect and perform treatment easier without holding a lighting device such as a flashlight or wearing a head lamp, thus can overcome the problem of holding multiple tools such as the oral mirror, lighting device and treatment apparatus at the same time.

In summation of the above description, the present invention provides a significant improvement over the conventional techniques and complies with the patent application requirements, and is submitted for review and granting of the commensurate patent rights.

What is claimed is:

1. An optical fiber teeth illumination apparatus, comprising a handle and a treatment device, the handle including a hollow lighting section at a front end to hold a lighting element and at least one optical fiber, the lighting element being connected to a power source, the lighting section including at least one radial aperture, the lighting element and the optical fiber being interposed by a condensing light element which focuses light generated by the lighting element to an input end of the optical fiber which includes at least one output end facing the aperture to project the light outside, the treatment device being fastened to a front side of the lighting section.

2. The optical fiber teeth illumination apparatus of claim 1, wherein the lighting section includes a screw hole at the front side, the treatment device including a fastening portion at a rear side fastenable to the screw hole.

3. The optical fiber teeth illumination apparatus of claim 1, wherein the treatment device is an oral mirror.

4. The optical fiber teeth illumination apparatus of claim 3, wherein the oral mirror includes two mirror surfaces on upper and lower sides thereof.

5. The optical fiber teeth illumination apparatus of claim 1, wherein the aperture is inclined towards the treatment device, the output end of the optical fiber being formed in a direction coincided with the inclined aperture to project the light towards the treatment device.
